(19) United States
(12) Patent Application Publication
(10) Pub. No.: US 2016/0124155 A1
(43) Pub. Date: May 5, 2016

(54) WAVELENGTH SELECTION SWITCH AND CONTROL METHOD FOR PHASE MODULATION ELEMENT

(71) Applicant: SUMITOMO ELECTRIC INDUSTRIES, LTD., Osaka-shi (JP)

(72) Inventor: Takafumi OHTSUKA, Yokohama-shi (JP)

(21) Appl. No.: 14/896,187

(22) PCT Filed: Jun. 6, 2013
(86) PCT No.: PCT/JP2013/065720

§ 371 Date: Dec. 4, 2015

(51) Int. Cl. G02B 6/35; G02B 6/293; G02B 6/26; G02F 1/31

(52) U.S. Cl. CPC G02B 6/356; G02F 1/31; G02B 6/3534; G02B 6/352; G02B 6/2931; G02B 6/29313; G02B 6/264

(57) ABSTRACT

A wavelength selective switch 1A includes a first port 11 and second ports 12a to 12d; a wavelength dispersive element 15; and a phase modulation element 17. Wavelength components L21 to L23 deflected by the phase modulation element 17 are respectively incident to the desired second ports 12b to 12d. A first control voltage pattern is supplied to the phase modulation element 17 in such a way that when the optical path of a wavelength component is switched from one to another of the second ports, the amount of phase modulation of a pre-switching phase modulation pattern is reduced while the period of a diffraction grating is maintained, and thereafter, a second control voltage pattern is supplied to the phase modulation element 17 so as to present a post-switching phase modulation pattern.

### TECHNICAL FIELD

The present invention relates to a wavelength selective switch, and a control method for a phase modulation element.

### BACKGROUND ART

Patent Literature 1 discloses a device that controls an optical path by independently modulating each wavelength component according to a diffraction grating-shaped phase modulation pattern using an optical-phased matrix device with a grating structure.

### CITATION LIST

### Patent Literature

[Patent Literature 1] United States Unexamined Patent Publication No. 2006/0067611

### SUMMARY OF INVENTION

### Technical Problem

There is a wavelength selective switch using a phase modulation element as one of wavelength selective switches. The phase modulation element is an element which includes multiple pixels arrayed in two dimensions, and is capable of performing phase modulation at each pixel according to the magnitude of a control voltage. Such a wavelength selective switch selects a port to be coupled with each of the wavelength components by presenting the diffraction grating-shaped phase modulation pattern to the phase modulation element, and controlling the deflective direction of each of the wavelength components incident to the phase modulation element.

The wavelength selective switch switches the coupling destination of each of the wavelength components from one port to another port. During this switching, the phase modulation pattern presented to the phase modulation element is switched from one pattern for deflecting the wavelength component to the one port to another pattern for deflecting the wavelength component to the other port. In many cases, a delay is present between the application of the control voltage and a change in the amount of phase modulation of the phase modulation element. The amount of phase modulation tends to slowly increase or decrease relative to a rapid change in the control voltage. Accordingly, a diffraction grating-shaped pattern with one period overlaps a diffraction grating-shaped pattern with another period before switching in a state where the diffraction grating-shaped pattern with the other period remains at the moment the phase modulation pattern presented to the phase modulation element is switched, the period structure of a diffraction grating collapses, and light is scattered. The scattering of light becomes a cause of noise light to other ports.

The present invention is made in light of this problem, and an object of the present invention is to provide a wavelength selective switch and a control method for a phase modulation element which are capable of suppressing the scattering of light when a coupling destination of a wavelength component is switched from one port to another port.

### Solution to Problem

In order to solve this problem, according to an aspect of the present invention, there is provided a wavelength selective switch including: a light input/output unit in which light input/output ports are lined up in a predetermined direction, with the light input/output ports including a first port through which light is input, and multiple second ports through which light is output; a wavelength dispersive element optically coupled to the light input/output unit; a phase modulation element including multiple pixels configured to perform phase modulation according to a control voltage applied to each of the pixels, and deflecting through diffraction the optical path of a wavelength component arriving at the phase modulation element from the first port through the wavelength dispersive element, toward any one of the multiple second ports by presenting a diffraction grating-shaped phase modulation pattern; and a control unit configured to supply a control voltage pattern to the phase modulation element so as to present the phase modulation pattern. when the optical path of the wavelength component is switched from one to another of the multiple second ports, the control unit supplies a first control voltage pattern such that the phase modulation amount of the phase modulation pattern for deflecting the optical path of the wavelength component toward a pre-switching second port is reduced while the period of a diffraction grating is maintained to the phase modulation element, and thereafter, supplies a second control voltage pattern for deflecting the optical path of the wavelength component toward the other second port to the phase modulation element.

In the wavelength selective switch, the first control voltage pattern may be a control voltage pattern for presenting a phase modulation pattern having a substantially uniform distribution of the phase modulation amount.

In the wavelength selective switch, the first control voltage pattern may be a control voltage pattern for presenting a phase modulation pattern configured by reversing the phase modulation pattern for deflecting the optical path of the wavelength component toward the pre-switching second port while using a predetermined phase as the axis of symmetry, and multiplying the phase value by k (here, k is a real number greater than zero).

In the wavelength selective switch, the first port and the multiple second ports may be disposed in such a way that 1^{st} order light of the wavelength component deflected by the phase modulation element is incident to a desired second port, and the optical axis of −1^{st} order light of the wavelength component may be positioned away from the second ports other than the desired second port.

In the wavelength selective switch, one portion of the light input/output ports and the remaining portion of the light input/output ports may be disposed such that the optical path of 0^{th} order light of the wavelength component deflected by the phase modulation element is interposed therebetween, and the one portion and the remaining portion may be disposed non-symmetrically with respect to the optical axis of the 0^{th} order light.

In the wavelength selective switch, ratios between the distances from the optical axis of the 0^{th} order light of the wavelength component deflected by the phase modulation element to the light input/output ports may be mutually prime.

In the wavelength selective switch, a center axis line of the first port may be positioned away from the optical axis of the 0^{th} order light of the wavelength component deflected by the phase modulation element.

In the wavelength selective switch, an isolator may be provided in the first port, or a phase modulation pattern for canceling the 0^{th} order light of the wavelength component deflected by the phase modulation element, may overlap the diffraction grating-shaped phase modulation pattern.

According to another aspect of the present invention, there is provided a control method for a phase modulation element which has multiple pixels configured to perform phase modulation according to a control voltage applied to each of the pixels, and deflects the optical path of light in a desired direction by presenting a diffraction grating-shaped phase modulation pattern, the method including: supplying, when the optical path of the light is switched from one direction to another direction, a first control voltage pattern such that the phase modulation amount of the phase modulation pattern for deflecting the optical path of the light toward the one direction is reduced while the period of a diffraction grating is maintained to the phase modulation element, and thereafter, supplying a second control voltage pattern for deflecting the optical path of the light toward the other direction to the phase modulation element.

### Advantageous Effects of Invention

According to the wavelength selective switch and the control method for the phase modulation element of the present invention, it is possible to suppress the scattering of light when a coupling destination of a wavelength component is switched from one port to another port.

### BRIEF DESCRIPTION OF DRAWINGS

FIG. 1 is a top schematic view illustrating the configuration of a wavelength selective switch in an embodiment of the present invention.

FIG. 2 is a side sectional view of the wavelength selective switch taken along line II-II in FIG. 1.

FIG. 3 is a view illustrating an example of the array of a light input/output port.

FIG. 4 is a sectional view illustrating the configuration of an LCOS-based phase modulation element as a specific example of the configuration of the phase modulation element.

FIG. 5 is a graph illustrating an actual phase change in a diffractive direction when a diffraction grating-shaped phase modulation pattern is presented to a modulation surface.

FIG. 6 is a view illustrating a state of the modulation surface when seen in a normal direction (light incidence direction) of the phase modulation element.

FIG. 7(a) is a graph illustrating a phase distribution on the modulation surface in the diffractive direction.

FIG. 7(b) is a graph illustrating the distribution of the light intensity of reflected light, which has arrived at the light input/output port, in a port array direction in the case illustrated in FIG. 7(a).

FIG. 8(a) is a graph illustrating a phase distribution on the modulation surface in the diffractive direction.

FIG. 8(b) is a graph illustrating the distribution of the light intensity of reflected light, which has arrived at the light input/output port, in the port array direction in the case illustrated in FIG. 8(a).

FIG. 9 shows graphs illustrating a state in which the second ports, that is, the coupling destinations of the wavelength components, are changed.

FIG. 10 is a graph illustrating the electro-optical characteristics of an LCOS-based phase modulation element.

FIG. 11 shows graphs illustrating a typical example of a phase modulation pattern that is presented to the phase modulation element according to a control voltage pattern supplied by a control unit.

FIG. 12 is a graph illustrating a phase modulation pattern in a comparative example.

FIG. 13 is a view illustrating the configuration of the light input and output input port in a first example.

FIG. 14 shows graphs each illustrating a change in the intensity of light incident to each second port over time in the first example.

FIG. 15 is a graph illustrating a change in the intensity of light incident to each second port over time in a comparative example.

FIG. 16 is a view illustrating the configuration of the light input/output port in a second example.

FIG. 17 shows graphs each illustrating a change in the intensity of light incident to each second port over time in the second example.

FIG. 18 is a graph illustrating a change in the intensity of light incident to each second port over time in a comparative example.

FIG. 19 shows graphs each illustrating a phase modulation pattern presented to the phase modulation element in a first modification example.

FIG. 20 shows graphs each illustrating a phase modulation pattern presented to the phase modulation element in the first modification example.

FIG. 21 shows graphs each illustrating a phase modulation pattern presented to the phase modulation element in the first modification example.

FIG. 22 is a schematic view illustrating the array of the light input/output port.

FIG. 23 is a view illustrating the relative dispositions of a first port and multiple second ports in a second modification example.

FIG. 24 is a graph illustrating a relationship between the light input/output port illustrated in FIG. 23 and the distribution of light intensities of diffracted lights arriving at the light input/output port.

FIG. 25 is a view illustrating the relative dispositions of the first port and the multiple second ports in a third modification example.

FIG. 26 is a view illustrating the relative dispositions of the first port and the multiple second ports in a fourth modification example.

### DESCRIPTION OF EMBODIMENTS

Hereinafter, a wavelength selective switch and a control method for a phase modulation element in an embodiment of the present will be described in detail with reference to the accompanying drawings. In the description of the drawings, the same reference signs are assigned to the same elements, and the description thereof will not be duplicated.

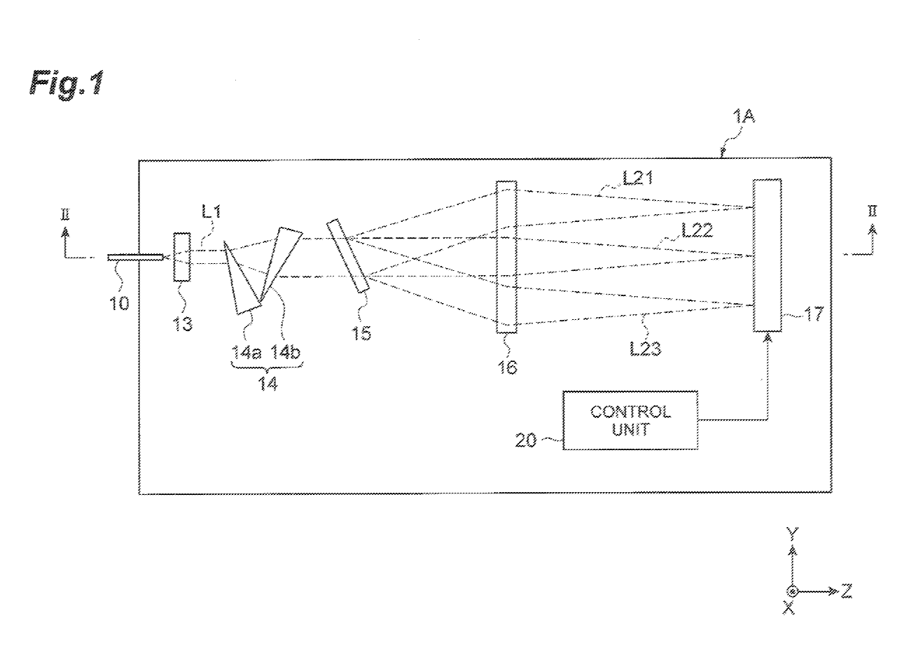

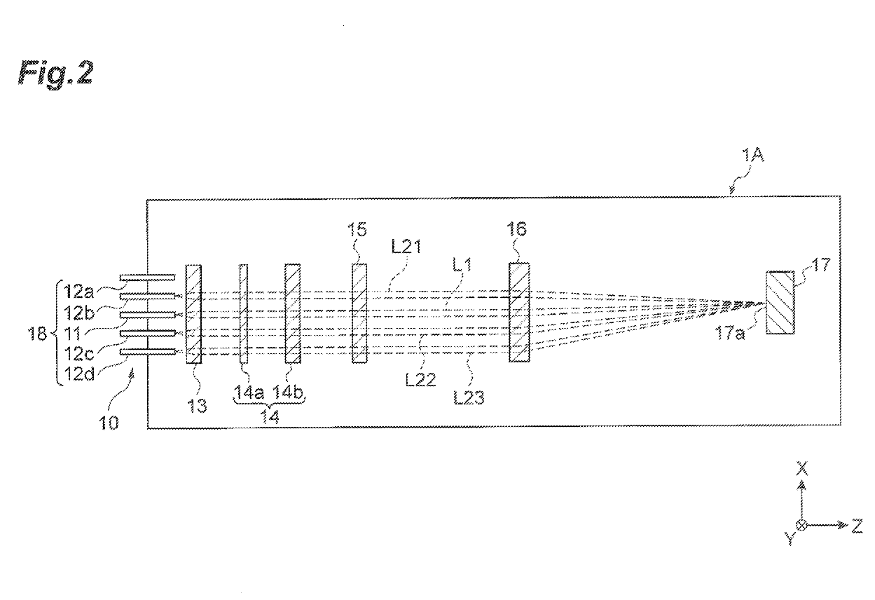

FIG. 1 is a top schematic view illustrating the configuration of a wavelength selective switch 1A in the embodiment of the present invention. FIG. 2 is a side sectional view of the wavelength selective switch 1A taken along line II-II in FIG. 1. For the purpose of easy understanding, an XYZ rectangular coordinate system is illustrated in FIGS. 1 and 2. The wavelength selective switch 1A has a substantially rectangular parallelepiped shape with upper and bottom surfaces along a Y-Z plane and four surfaces along an X-axis direction.

As illustrated in FIGS. 1 and 2, the wavelength selective switch 1A includes a light input/output unit 10. The light input/output unit 10 has a light input/output port 18 including a first port 11 through which light is input to the wavelength selective switch 1A from the outside, and multiple second ports 12 through which the light is output to the outside of the wavelength selective switch 1A. Four second ports 12a to 12d are representatively illustrated in FIG. 2.

Light L1 containing multiple wavelength components is input to the wavelength selective switch 1A from the outside through the first port 11. For example, the light L1 is signal light in wavelength multiplexed communication. The wavelength selective switch 1A disperses the light L1, which is input to the first port 11, into its constituent wavelength components, and respectively outputs the wavelength components through the multiple second ports 12a to 12d. As an example, FIG. 1 illustrates three wavelength components L21, L22, and L23, and the four second ports 12a to 12d. The three wavelength components L21, L22, and L23 are respectively output through three second ports 12b, 12c, and 12d of the four second ports 12a to 12d.

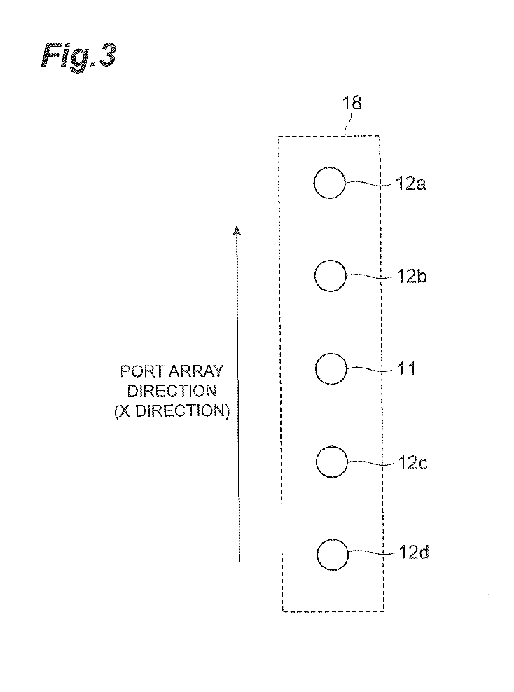

The multiple second ports 12a to 12d are disposed in such a way as to be lined up in a predetermined direction. For example, the predetermined direction is the X-axis direction. In the embodiment, the first port 11 and the multiple second ports 12a to 12d are disposed in such a way as to be lined up in a row in the X-axis direction. In the following description, the X-axis direction may be referred to as a port array direction. FIG. 3 is a view illustrating an example of the array of the light input/output port 18, and illustrates a state of the light input/output port 18 that is seen in a Z-axis direction. As illustrated in FIG. 3, in the embodiment, the first port 11 is disposed at the center of the light input/output port 18. The second ports 12a and 12b, that is one portion of the multiple second ports 12a to 12d, are disposed on one side of the first port 11 in the port array direction. The second ports 12c and 12d, that is the remaining portion of the multiple second ports 12a to 12d, are disposed on the other side of the first port 11 in the port array direction. Each of the first port 11 and the multiple second ports 12a to 12d is suitably formed of an optical waveguide member such as an optical fiber.

With reference again to FIGS. 1 and 2, the wavelength selective switch 1A further includes a collimator lens 13; an anamorphic optical system 14; a wavelength dispersive element 15; a converging lens 16; a phase modulation element 17; and a control unit 20.

The collimator lens 13 is optically coupled to the first port 11. The collimator lens 13 aligns (collimates) the light L1 in parallel, with the light L1 being input from the first port 11. In addition, the collimator lens 13 is optically coupled to the multiple second ports 12a to 12d. The collimator lens 13 converges the dispersed wavelength components L21 to L23 to the corresponding second ports (for example, 12b to 12d).

The anamorphic optical system 14 receives the light L1 through the collimator lens 13. The anamorphic optical system 14 converts the light L1 in such a way that the section (which is perpendicular to the optical axis) of the light L1 has a flat shape extending in a direction (for example, a Y-axis direction) intersecting the aforementioned predetermined direction (in the embodiment, the X-axis direction). In the following description, the Y-axis direction may be referred to as a dispersive direction. For example, the anamorphic optical system 14 is suitably formed of prisms 14a and 14b. The anamorphic optical system 14 magnifies the width of the light L1 in such a way that the width of the light L1 is increased in the Y-axis direction, and thus the section of the light L1 perpendicular to the optical axis has a flat shape extending in the Y-axis direction. One surface of the anamorphic optical system 14 is optically coupled to the multiple second ports 12a to 12d through the collimator lens 13, and the other surface of the anamorphic optical system 14 is optically coupled to a modulation surface 17a (to be described later) of the phase modulation element 17. The anamorphic optical system 14 minifies the widths of the wavelengths components L21 to L23 in the Y-axis direction, which are reflected by the modulation surface 17a, toward the corresponding second ports (for example, 12b to 12d). The anamorphic optical system 14 may be formed of an optical component (for example, cylindrical lens) having optical power in only one of the X-axis direction and the Y-axis direction. The anamorphic optical system 14 may be configured to magnify the width of the light L1 in such a way that the width of the light L1 is increased in the Y-axis direction. Alternatively, the anamorphic optical system 14 minifies the width of the light L1 in such a way that the width of the light L1 is decreased in the X-axis direction.

The wavelength dispersive element (dispersive element) 15 receives the light L1 input from the first port 11, and disperses the light L1 into the wavelength components L21 to L23. In the embodiment, the wavelength dispersive element 15 receives the light L1 through the collimator lens 13 and the anamorphic optical system 14. The wavelength dispersive element 15 is suitably formed of a plate-like member of which the surface is provided with a diffraction grating. The wavelength components L21 to L23 of the light L1 dispersed by the wavelength dispersive element 15 propagate in different optical-axis directions, respectively. In the embodiment, the wavelength components L21 to L23 are dispersed in the aforementioned dispersive direction (Y-axis direction).

The converging lens 16 is disposed on an optical path between the wavelength dispersive element 15 and the phase modulation element 17. The wavelength dispersive element 15 and the phase modulation element 17 are optically coupled together through the converging lens 16. The converging lens 16 converges the wavelength components L21 to L23 passing through the wavelength dispersive element 15 toward the modulation surface 17a of the phase modulation element 17. The converging lens 16 collimates the wavelength components L21 to L23 deflected by the modulation surface 17a toward the wavelength dispersive element 15.

The phase modulation element 17 includes multiple pixels, each of which performs phase modulation according to a control voltage applied to each of the pixels. The phase modulation element 17 deflects through diffraction the optical path of the wavelength components L21 to L23 arriving at the phase modulation element 17 from the first port 11 through the wavelength dispersive element 15 and the like in an X-Z plane, by presenting a diffraction grating-shaped phase modulation pattern. In the following description, the X-axis direction may be referred to as a deflective direction. At this time, the deflection angles of the wavelength components L21 to L23 are different from each other in the X-Z plane. The deflection angles are set in such a way that the wavelength components L21 to L23 are respectively incident to desired second ports (for example, 12b to 12d). The control unit 20 supplies a control voltage pattern to the phase modulation element 17 so as to present the diffraction grating-shaped phase modulation pattern.

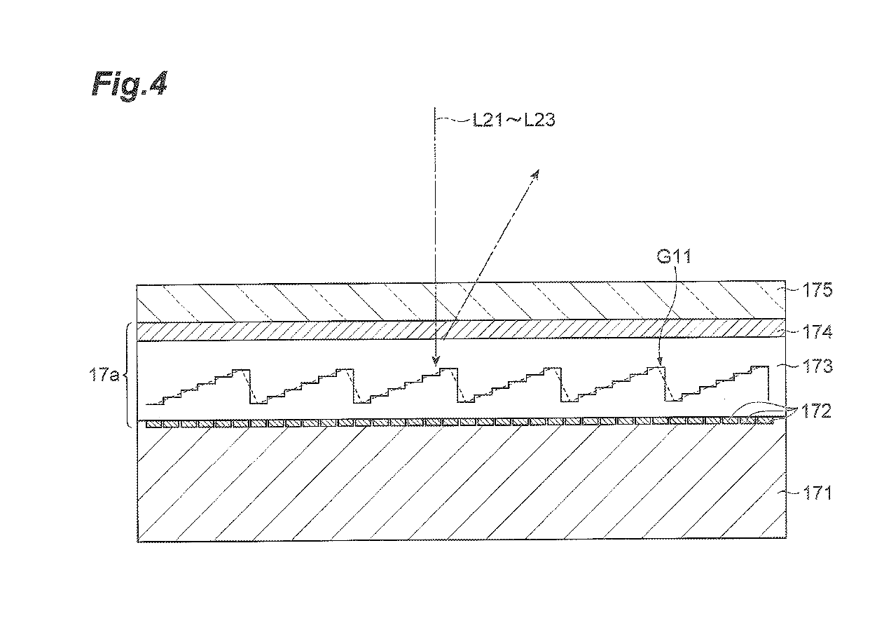

FIG. 4 is a sectional view illustrating the configuration of a liquid crystal on silicon (LCOS)-based phase modulation element 17 as a specific example of the configuration of the phase modulation element 17. As illustrated in FIG. 4, the phase modulation element 17 includes a silicon substrate 171, and multiple pixel electrodes 172 provided on a main surface of the silicon substrate 171. The multiple pixel electrodes 172 are arrayed in a grating pattern along the main surface of the silicon substrate 171. A liquid crystal layer 173, a transparent electrode 174, and a cover glass 175 are sequentially disposed on the main surface of the silicon substrate 171. The phases of the wavelength components L21 to L23 incident to the liquid crystal layer 173 are modulated according to the magnitudes of electric fields formed between the transparent electrode 174 and the multiple pixel electrodes 172. Electric fields with different magnitudes are respectively formed for the pixel electrodes 172, and thus the amount of phase modulation is different between the pixel electrodes. The modulation surface 17a is mainly formed of the multiple pixel electrodes 172; the liquid crystal layer 173; and the transparent electrode 174. In FIG. 4, a graph G11 conceptually illustrates the amount of phase modulation of each of the pixel electrodes when the diffraction grating-shaped phase modulation pattern is presented to the modulation surface 17a.

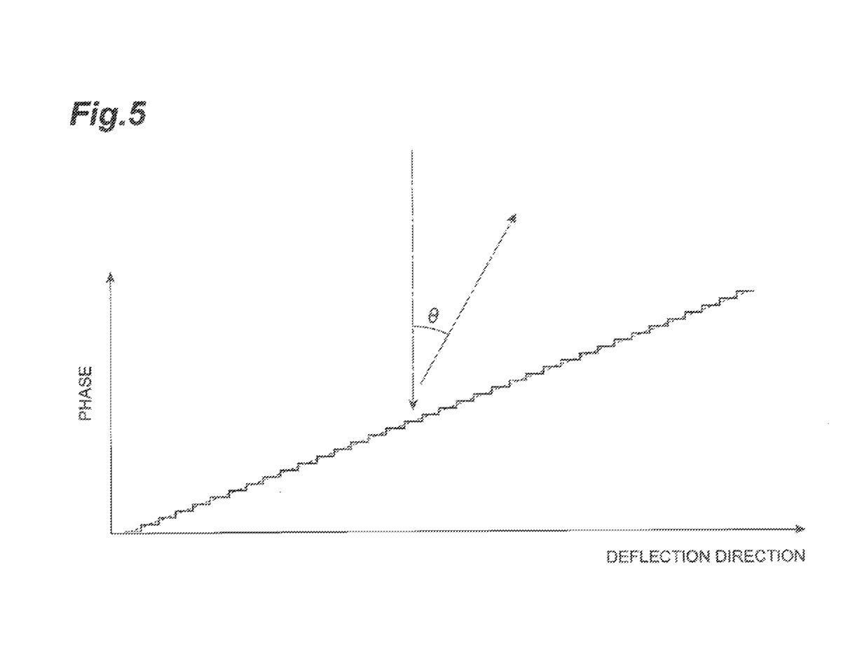

FIG. 5 is a graph illustrating an actual phase change in the deflection direction when the diffraction grating-shape phase modulation pattern is presented to the modulation surface 17a. As conceptually illustrated in FIG. 4, on the modulation surface 17a, the amount of phase modulation stepwisely increases from 0 (rad) to 2π (rad), and when the amount of phase modulation reaches 2π (rad), the amount of phase modulation returns to 0 (rad) again, and stepwisely increases from 0 (rad) to 2π (rad). The diffraction grating-shaped phase modulation pattern, in which the amount of phase modulation increases stepwisely and monotonically as illustrated in FIG. 5, is practically realized by such a phase modulation pattern. When the wavelength components L21 to L23 are incident to the modulation surface 17a to which such a phase modulation pattern is presented, the wavelength components 121 to L23 are diffracted at an emitting angle θ corresponding to the period of the diffraction grating.

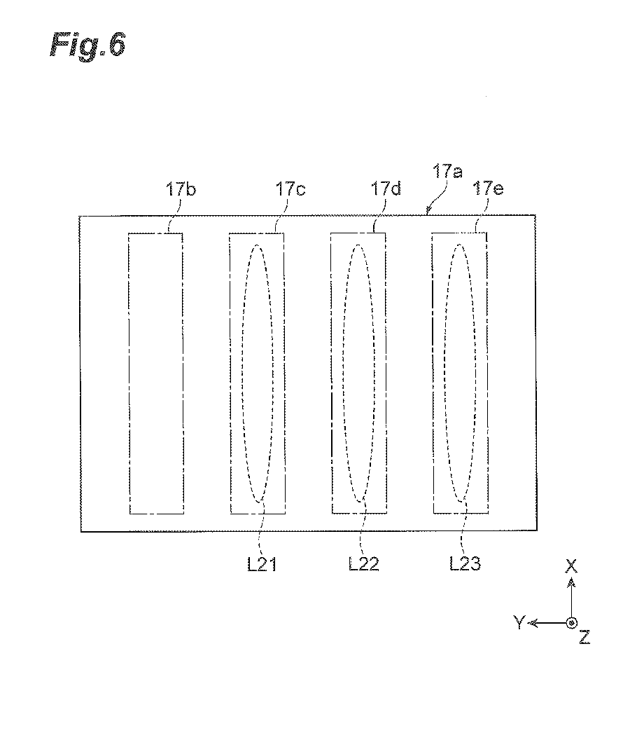

FIG. 6 is a view illustrating a state of the modulation surface 17a when seen in a normal direction (light incidence direction). The modulation surface 17a includes multiple phase modulation regions 17b to 17e lining up along the Y-axis direction (the dispersive direction), and the wavelength components L21 to L23 are selectively incident to the phase modulation regions 17b to 17e. In the example illustrated in FIG. 6, the wavelength components L21 to L23 are respectively incident to the phase modulation regions 17c, 17d, and 17e. The phase modulation regions 17c to 17e diffract the wavelength components L21 to L23 toward the corresponding second ports 12b to 12d by presenting the diffraction gratings with different periods. The wavelength components L21 to L23 reflected by the phase modulation element 17 are aligned in parallel by the converging lens 16, and arrive at the corresponding second ports 12b to 12d through the anamorphic optical system 14 and the collimator lens 13.

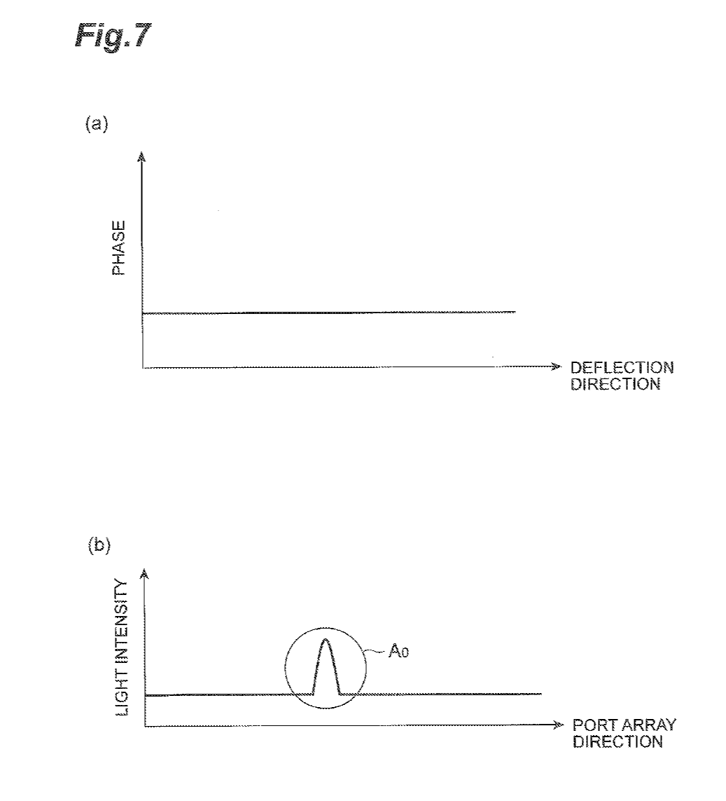

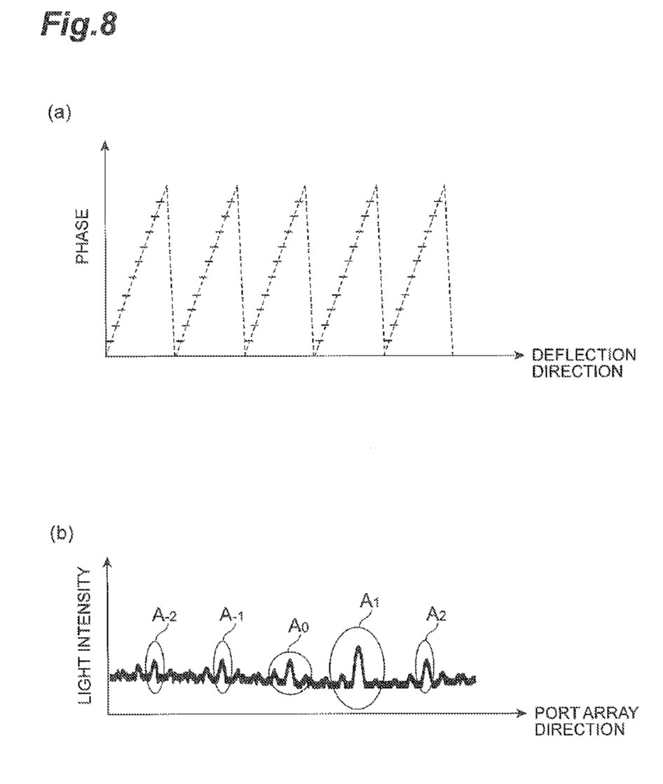

FIGS. 7(a) and 8(a) each illustrate a phase distribution on the modulation surface 17a in the deflection direction. FIGS. 7(b) and 8(b) are graphs each illustrating the distribution of the light intensity of diffracted light, which has arrived at the light input/output port 18, in the port array direction in the cases illustrated in FIGS. 7(a) and 8(a), respectively. As illustrated in FIG. 7(a), when the amount of phase modulation presented to the modulation surface 17a is constant in the deflection direction, as illustrated in FIG. 7(b), only 0^{th} order light A₀ arrives at the light input/output port 18. In contrast, as illustrated in FIG. 8(a), when the amount of phase modulation presented to the modulation surface 17a forms a diffraction grating shape in the deflection direction, as illustrated in FIG. 8(b), the light intensity of the 0^{th} order light A₀ decreases, and the light intensity of adjacent 1^{st} order light A₁ increases. Accordingly, the periods of the diffraction gratings of the phase modulation regions 17c to 17e illustrated in FIG. 6 are set in such a way that the 1^{st} order lights A₁ of the wavelength components L21 to L23 incident to the modulation surface 17a are respectively incident to the second ports 12b to 12d. In addition to the 1^{st} order light A₁, FIG. 8(b) illustrates multiple lights including a 2^{nd} order light A₂, 3^{rd} or higher-order lights, a −1^{st} order light A₋₁, a −2^{nd} order light A₋₂, and −3^{rd} or negative higher-order lights.

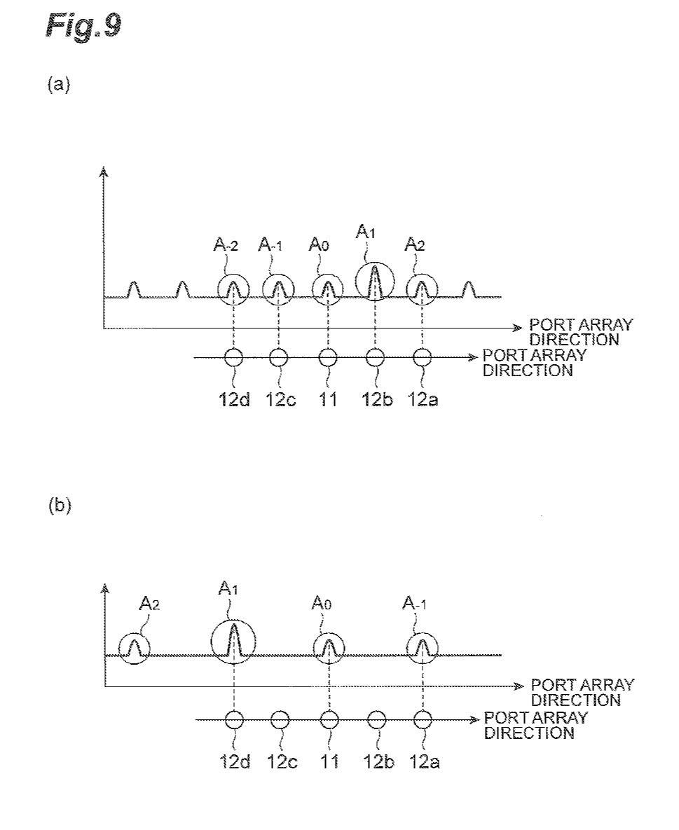

FIG. 9 shows graphs illustrating a state in which the second ports, that is the coupling destinations of the wavelength components, are changed. FIGS. 9(a) and 9(b) illustrate the distribution of the light intensities of diffracted lights arriving at the light input/output port 18, and the positions of the second ports 12a to 12d. A predetermined phase modulation pattern is presented, and thus any one of the wavelength components is coupled to the second port 12b. At this time, as illustrated in FIG. 9(a), the optical axis of the 1^{st} order light A₁ of the wavelength component is substantially coincident with the center axis line of the second port 12b. For example, when the coupling destination of the wavelength component is changed to the second port 12d from this state, as illustrated in FIG. 9(b), the phase modulation pattern is switched to a phase modulation pattern such that the optical axis of the 1^{st} order light A₁ of the wavelength component becomes substantially coincident with the center axis line of the second port 12d.

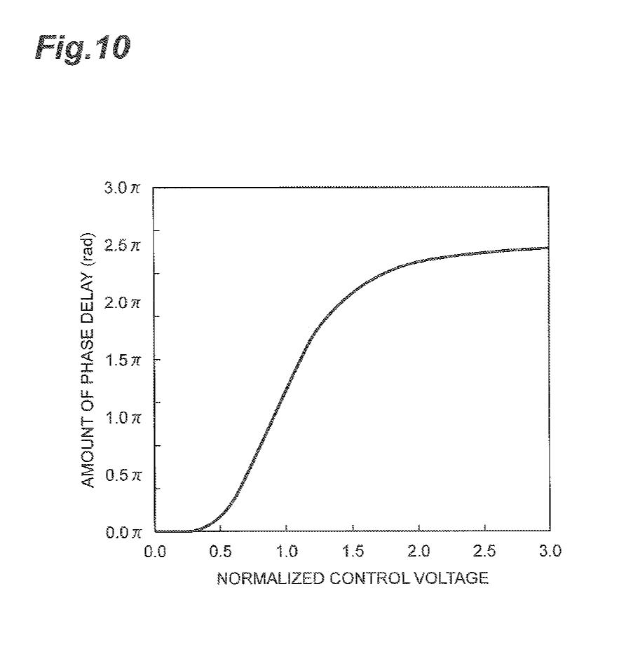

In many cases, a delay is present between the application of the control voltage and a change in the amount of phase modulation of the phase modulation element 17. The amount of phase modulation tends to slowly increase or decrease relative to a rapid change in the control voltage. FIG. 10 is a graph illustrating the electro-optical characteristics of the LCOS-based phase modulation element as an example. As illustrated in FIG. 10, in the LCOS-based phase modulation element, the amount of phase delay increases to the extent that the control voltage is increased. Accordingly, when a diffraction grating-shaped pattern with one period overlaps a diffraction grating-shaped pattern with another period before switching in a state where the diffraction grating-shaped pattern with the other period remains at the moment the phase modulation pattern presented to the phase modulation element 17 is switched, the period structure of a diffraction grating collapses, and the wavelength components incident to the phase modulation element 17 are scattered. The same phenomenon occurs when the wavelength selective switch adopts the LCOS-based phase modulation element in which the amount of phase delay decreases to the extent that the control voltage is increased.

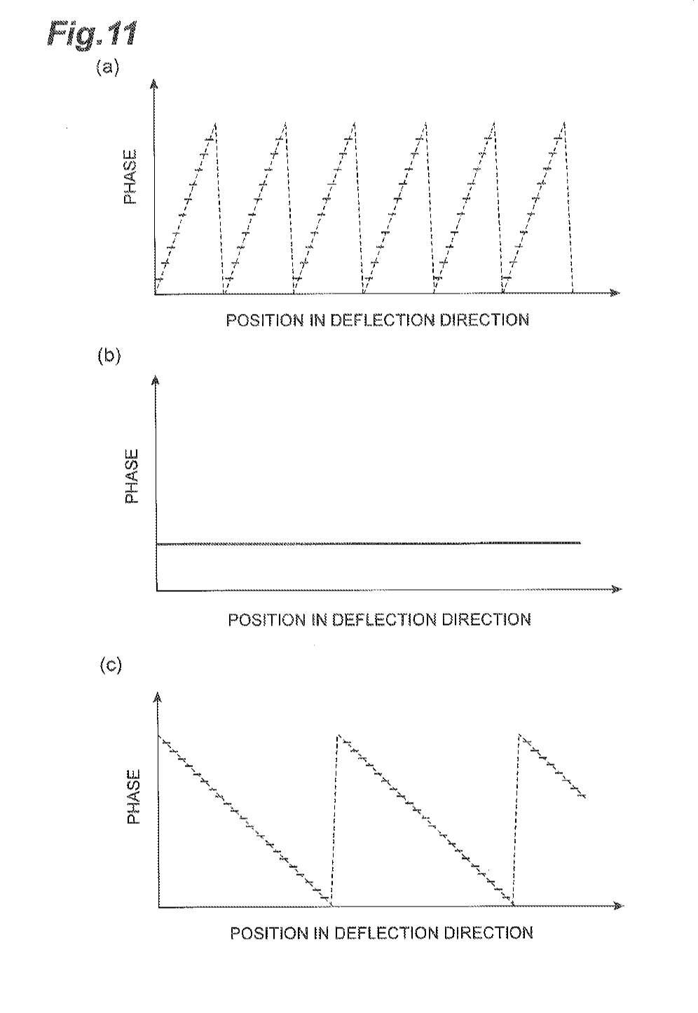

In order to solve this problem, the control unit 20 supplies a control voltage pattern (to be described later) to the phase modulation element 17. FIG. 11 shows graphs illustrating a typical example of a phase modulation pattern that is presented to the phase modulation element 17 according to a control voltage pattern supplied by the control unit 20.

When the coupling destination of a wavelength component is switched from one (for example, the second port 12b) to another (for example, the second port 12d) of the multiple second ports 12a to 12d, the control unit 20 performs the following operation. The phase modulation element 17 is deemed to present a phase modulation pattern (that is, a pre-switching phase modulation pattern) for deflecting the optical path of the wavelength component toward the one second port (refer to FIG. 11(a)). First, the control unit 20 supplies a first control voltage pattern to the phase modulation element 17 so as to reduce the amount of phase modulation of the phase modulation pattern. The first control voltage pattern is a pattern reducing the amount of phase modulation of the phase modulation pattern while maintaining the period of the diffraction grating. As an example of the phase modulation pattern presented according to the first control voltage pattern, FIG. 11(b) illustrates a phase modulation pattern through which the distribution of the amounts of phase modulation is substantially uniform. When the first control voltage pattern is supplied to the phase modulation element 17 so that the phase modulation pattern illustrated in FIG. 11(b) is presented, while the period of the diffraction grating is maintained, the amount of phase modulation is gradually reduced such that the phase modulation pattern illustrated in FIG. 11(a) gets close to the phase modulation pattern illustrated in FIG. 11(b).

In this manner, the pre-switching phase modulation pattern disappears while the period of the diffraction grating is maintained. Therefore, it is possible to suitably maintain the distribution of the 1^{st} order light A₁ and the like illustrated in FIG. 9(a) in a state wherein the wavelength components incident to the phase modulation element 17 are not scattered even after the first control voltage pattern is supplied to the phase modulation element 17.

Thereafter, the control unit 20 supplies a second control voltage pattern to the phase modulation element 17 so as to present a phase modulation pattern (for example, refer to FIG. 11(c)) for deflecting the optical path of the wavelength component toward the other second port. The coupling destination of the wavelength component is switched from the one second port to the other second port by the aforementioned operation.

As described above, in the wavelength selective switch 1A according to the embodiment, when the second port, that is the coupling destination of a wavelength component is switched, first, the control unit 20 supplies the first control voltage pattern to the phase modulation element 17 so as to reduce the amount of phase modulation of a pre-switching phase modulation pattern while maintaining the period of a diffraction grating. Thereafter, the control unit 20 supplies the second control voltage pattern to the phase modulation element 17 after the switching is complete. Therefore, it is possible to present a diffraction grating-shaped pattern with one period in a state where a diffraction grating-shaped pattern with another period before switching disappears (or is sufficiently reduced). As a result, it is possible to suppress the scattering of the wavelength while maintaining a period structure of the diffraction grating.

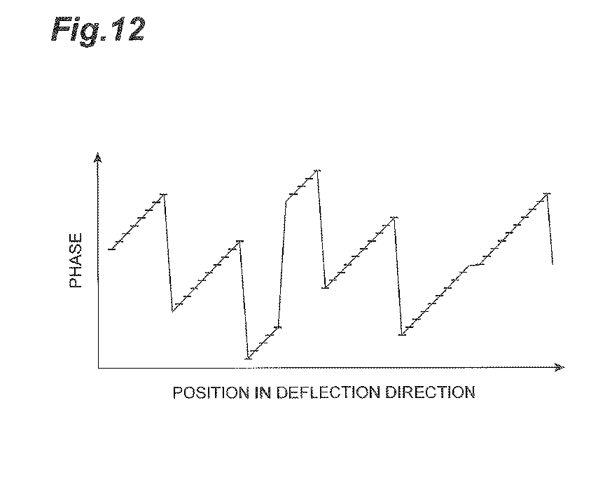

FIG. 12 illustrates a comparative example, and is a graph illustrating a phase modulation pattern presented to the phase modulation element 17 when the post-switching phase modulation pattern (illustrated in FIG. 11(c)) is presented without transition from the pre-switching phase modulation pattern (illustrated in FIG. 11(a)) to the phase modulation pattern illustrated in FIG. 11(b). As illustrated in FIG. 12, in this case, the period structure of the diffraction grating collapses, and the distribution of the 1^{st} order light A₁ and the like illustrated in FIG. 8(b) is not generated. As a result, light diffracted by the phase modulation element 17 spreads over the entirety of the light input/output port 18, and becomes a cause of noise light toward the second ports other than a desired coupling destination. The wavelength selective switch 1A in the embodiment solves this problem.

As in the embodiment, the first control voltage pattern may be a control voltage pattern for presenting a phase modulation pattern (refer to FIG. 11(b)) through which the distribution of the amounts of phase modulation is substantially uniform. As a result, it is possible to suitably reduce the amount of phase modulation of the phase modulation pattern while maintaining the period of a diffraction grating of a pre-switching phase modulation pattern.

### First Example

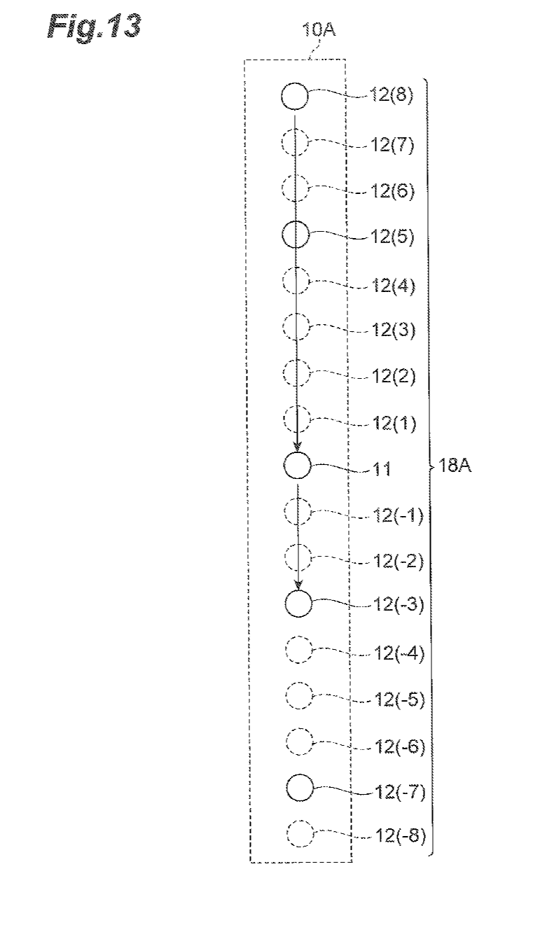

A first example of the embodiment will be described. FIG. 13 is a view illustrating the configuration of a light input and output input unit 10A used in the example. As illustrated in FIG. 13, the light input/output unit 10A includes a light input/output port 18A. The light input/output port 18A includes one first port 11 and 16 second ports 12(n). Here, n represents a port number. Numbers from n=1 to n=8 are sequentially assigned to the ports on one side of the first port 11 from the port closest to the first port 11. Numbers from n=−1 to n=−8 are sequentially assigned to the ports on the other side of the first port 11 from the port closest to the first port 11. The second ports used as output ports of an optical communication system are illustrated by a solid line, and other ports are illustrated by a dotted line. In the example, the second ports used as the output ports of the optical communication system are a second port 12(−7), the −7^{th} port; a second port 12(−3), the −3^{rd} port; a second port 12(5), the 5^{th} port; and a second port 12(8), the 8^{th} port.

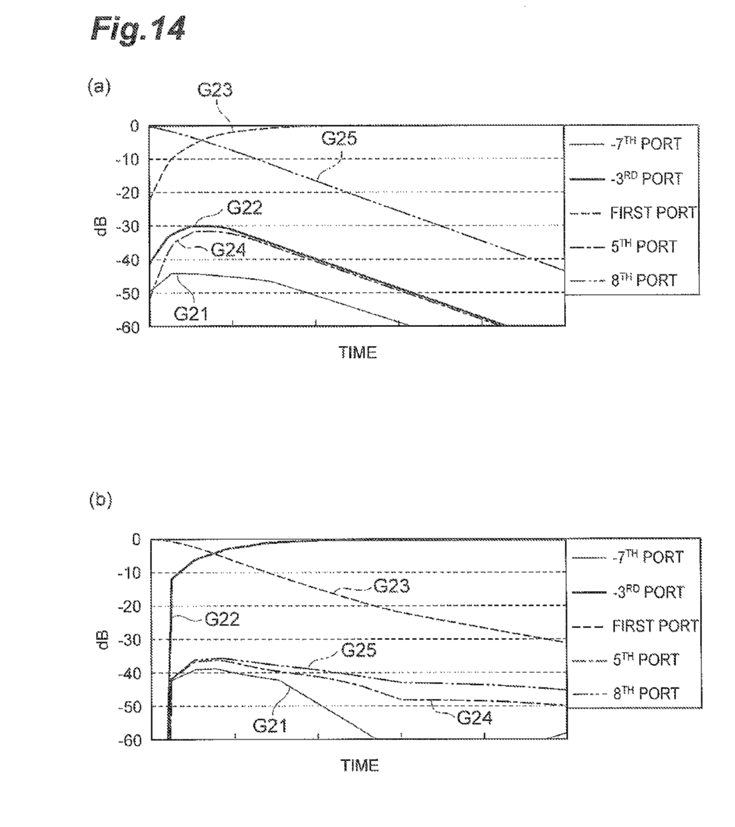

In the light input/output port 18A, the coupling destination of a wavelength component is switched from the second port 12(8) (the 8^{th} port) to the second port 12(−3) (the −3^{rd} port). FIG. 14 shows graphs each illustrating a change in the intensity of light incident to each second port over time in this case. FIG. 14(a) illustrates a change from when the diffraction grating-shaped phase modulation pattern before switching (illustrated in FIG. 11(a)) is presented until when the pre-switching phase modulation pattern disappears by presenting the phase modulation pattern illustrated in FIG. 11(b). FIG. 14(b) illustrates a change from when the pre-switching phase modulation pattern has disappeared until when the diffraction grating-shaped phase modulation pattern after switching (illustrated in FIG. 11(c)) is presented. Graphs G21 to G25 respectively illustrate the intensities of lights incident to the second port 12(−7) (the −7^{th} port), the second port 12(−3) (the −3^{rd} port), the first port 11, the second port 12(5) (the 5^{th} port), and the second port 12(8) (8^{th} port).

As illustrated in FIG. 14(a), during the time period from when the pre-switching phase modulation pattern is presented until when the phase modulation pattern disappears, the intensity (illustrated by the graph G25) of light incident to the second port 12(8) (the 8^{th} port), which is the second port as a pre-switching coupling destination, decreases gradually, and the intensity (illustrated by the graph G23) of light incident to the first port 11 increases. The reason for an increase in the intensity of light incident to the first port 11 is that when a diffraction grating-shaped pattern is not presented to the phase modulation element 17, the phase modulation element 17 simply serves as a reflecting mirror.

As illustrated in FIG. 14(b), during the time period from when the pre-switching phase modulation pattern has disappeared until when the post-switching phase modulation pattern is presented, the intensity (illustrated by the graph G23) of light incident to the first port 11 decreases gradually, and the intensity (illustrated by the graph G22) of light incident to the second port 12(−3) (the −3^{rd} port), which is a second port as a post-switching coupling destination, increases.

In FIGS. 14(a) and 14(b), the intensities (illustrated by the graphs G21 and G24) of light incident to the second port 12(−7) (the −7^{th} port) and the second port 12(5) (the 5^{th} port), that is, the second ports other than the second port 12(8) (the 8^{th} port) (which is a pre-switching coupling destination) and the second port 12(−3) (the −3^{rd} port) (which is a post-switching coupling destination) are less than −30 dB with respect to the intensity of light incident to the second port which is a coupling destination. When the intensities of lights incident to the second ports other than the second ports which are coupling destinations are less than −30 dB, the impact on optical communication can be sufficiently suppressed.

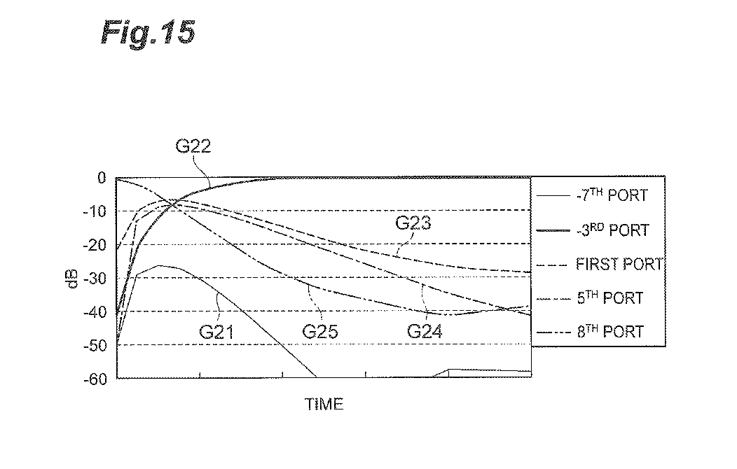

FIG. 15 illustrates a comparative example, and is a graph illustrating a change in the intensity of light incident to each of the second ports over time when the post-switching phase modulation pattern (illustrated in FIG. 11 (c)) is presented without transition from the pre-switching phase modulation pattern (illustrated in FIG. 11(a)) to the phase modulation pattern illustrated in FIG. 11(b). In this case, with reference to FIG. 15, it can be understood that the intensities (illustrated by the graphs G21 and G24) of lights incident to the second ports other than the second ports, which are pre-switching and post-switching coupling destinations, are greater than or equal to −30 dB with respect to the intensity of light incident to the second port which is a coupling destination.

### Second Example

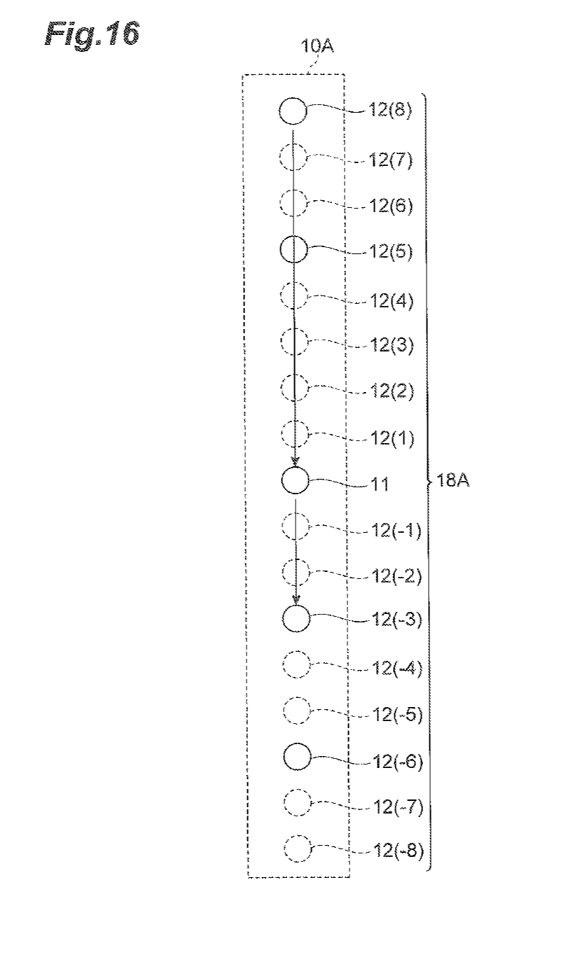

A second example of the embodiment will be described. FIG. 16 is a view illustrating the configuration of the light input/output unit 10A used in the example. The light input/output port 18A of the light input/output unit 10A has the configuration as in the first example. In the example, the second ports used as the output ports of the optical communication system are a second port 12(−6), the −6^{th} port; the second port 12(−3), the −3^{rd} port; the second port 12(5), the 5^{th} port; and the second port 12(8), the 8^{th} port.

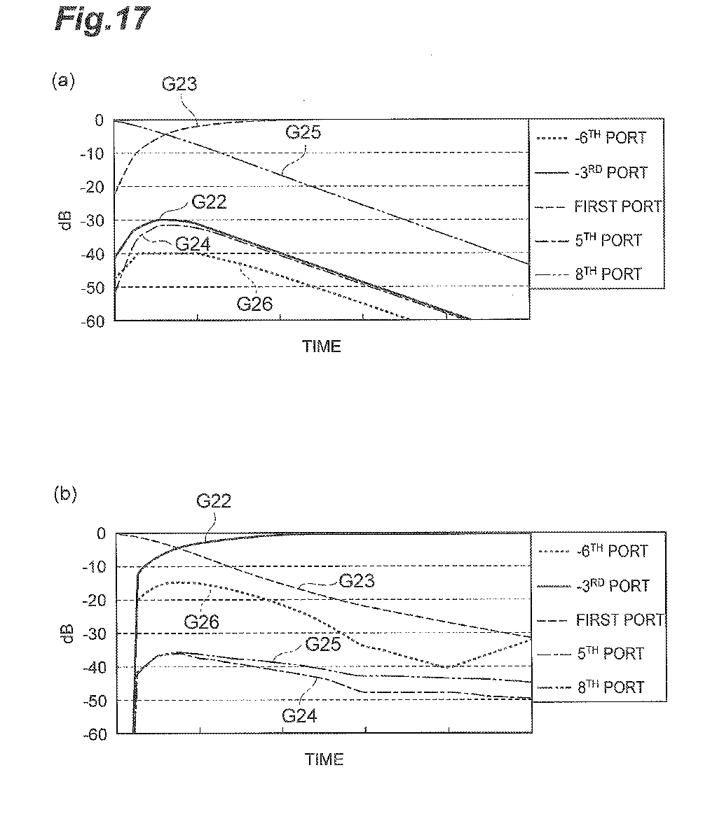

Also in the example, the coupling destination of a wavelength component is switched from the second port 12(8) (the 8^{th} port) to the second port 12(−3) (the −3^{rd} port). FIG. 17 shows graphs each illustrating a change in the intensity of light incident to each second port over time in this case. FIGS. 17(a) and 17(b) illustrate the changes over the same time periods as those in FIGS. 14(a) and 14(b), respectively. The graph G26 illustrates the intensity of light incident to the second port 12(−6) (the 6^{th} port).

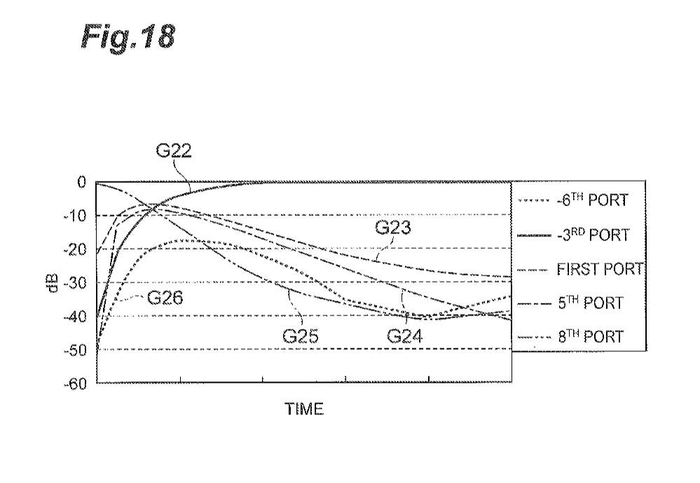

As illustrated in FIGS. 17(a) and 17(b), also in the example, it can be understood that the intensity (illustrated by the graph G24) of light incident to the second port 12(5) (the 5^{th} port), that is, a second port other than the second port 12(8) (the 8^{th} port) (which is a pre-switching coupling destination) and the second port 12(−3) (the −3^{rd} port) (which is a post-switching coupling destination) are less than −30 dB with respect to the intensity of light incident to the second port which is a coupling destination, and the intensity of light incident to the second port 12(5) is effectively reduced. FIG. 18 illustrates a comparative example, and is a graph illustrating a change in the intensity of light incident to each of the second ports when a phase modulation pattern is switched without transitioning to the phase modulation pattern illustrated in FIG. 11(b). With reference to FIG. 18, the intensities (illustrated by the graphs G24 and G26) of lights incident to the second ports other than the ports, which are pre-switching and post-switching coupling destinations, are greater than or equal to −30 dB with respect to the intensity of light incident to the second port which is a coupling destination.

In the example, as illustrated in FIG. 17(b), the intensity (illustrated by the graph G26) of light incident to the second port 12(−6) (the −6^{th} port) is greater than or equal to −30 dB with respect to the intensity of light incident to the second port which is a coupling destination. The reason for this is that the 2^{nd} order light A₂ illustrated in FIG. 8(b) is incident to the second port 12(−6) (the −6^{th} port). A method of solving this problem will be described later.

### First Modification Example

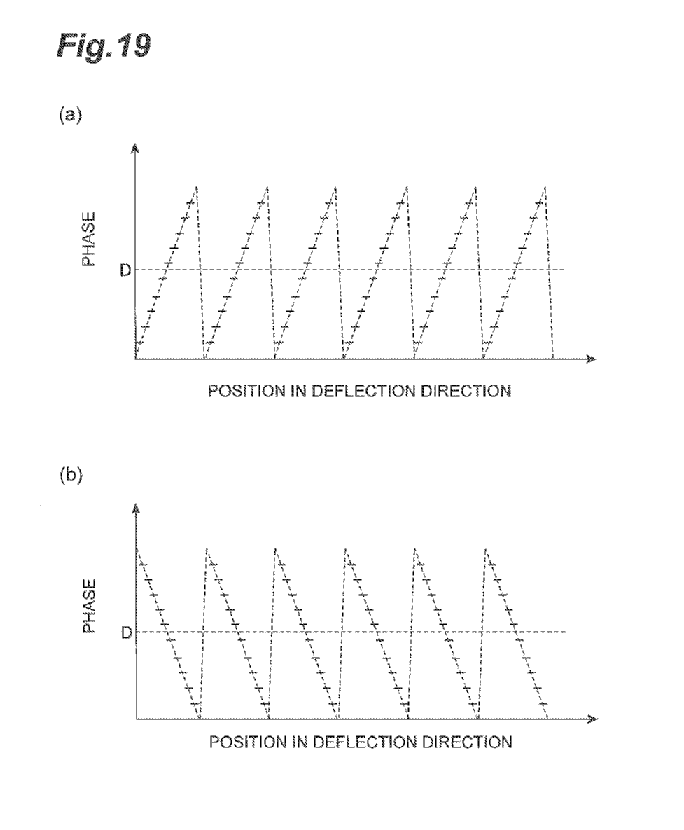

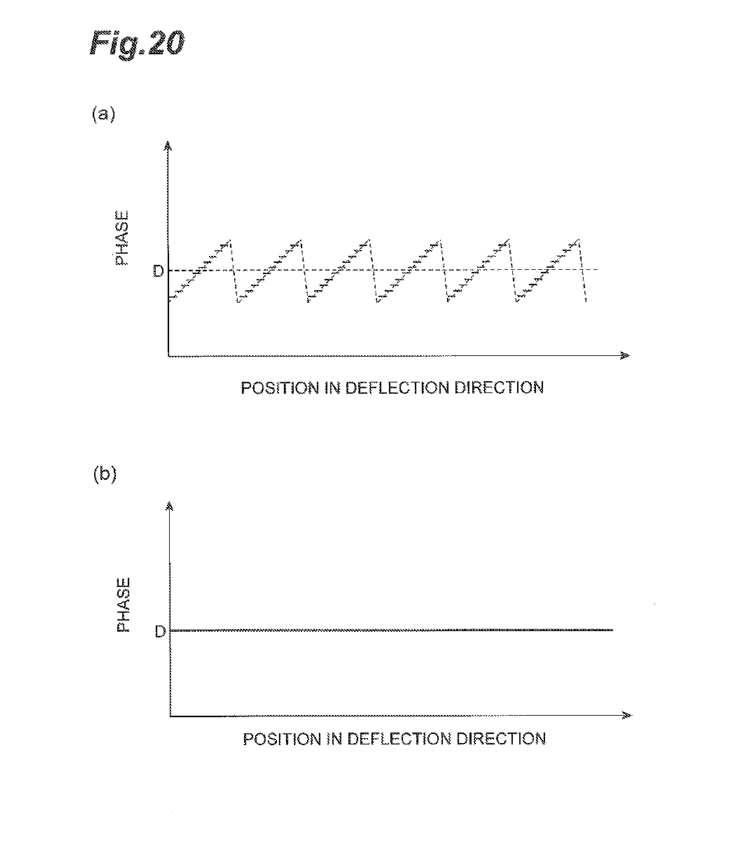

A first modification example of the embodiment will be described. In the modification example, when the second port, that is, a coupling destination of a wavelength component is switched, the control unit 20 supplies a control voltage pattern (to be described below) to the phase modulation element 17. FIGS. 19 and 20 each shows a graph illustrating a phase modulation pattern presented to the phase modulation element 17 in the modification example.

The phase modulation element 17 is deemed to present a pre-switching phase modulation pattern which is illustrated in FIG. 19(a). As the first control voltage pattern such that the amount of phase modulation of the phase modulation pattern is reduced while the period of a diffraction grating is maintained, the control unit 20 supplies a control voltage pattern to the phase modulation element 17 for presenting the phase modulation pattern illustrated in FIG. 19(b). The phase modulation pattern illustrated in FIG. 19(b) is a phase modulation pattern configured by turning the pre-switching phase modulation pattern (illustrated in FIG. 19(a)) upside down while using a predetermined phase D as the axis of symmetry.

When the first control voltage pattern is supplied to the phase modulation element 17 so as to present the phase modulation pattern illustrated in FIG. 19(b), as illustrated in FIG. 20(a), the amount of phase modulation of the phase modulation pattern illustrated in FIG. 19(a) decreases gradually while the period of a diffraction grating is maintained. Finally, the phase modulation pattern gets close to the phase modulation pattern illustrated in FIG. 20(b) through which the distribution of the amounts of phase modulation is substantially uniform.

Also in the modification example, in this manner, the pre-switching phase modulation pattern disappears while the period of the diffraction grating is maintained. Therefore, it is possible to suitably maintain the distribution of the 1^{st} order light A₁ and the like illustrated in FIG. 9(a) in a state where the wavelength components incident to the phase modulation element 17 are not scattered.

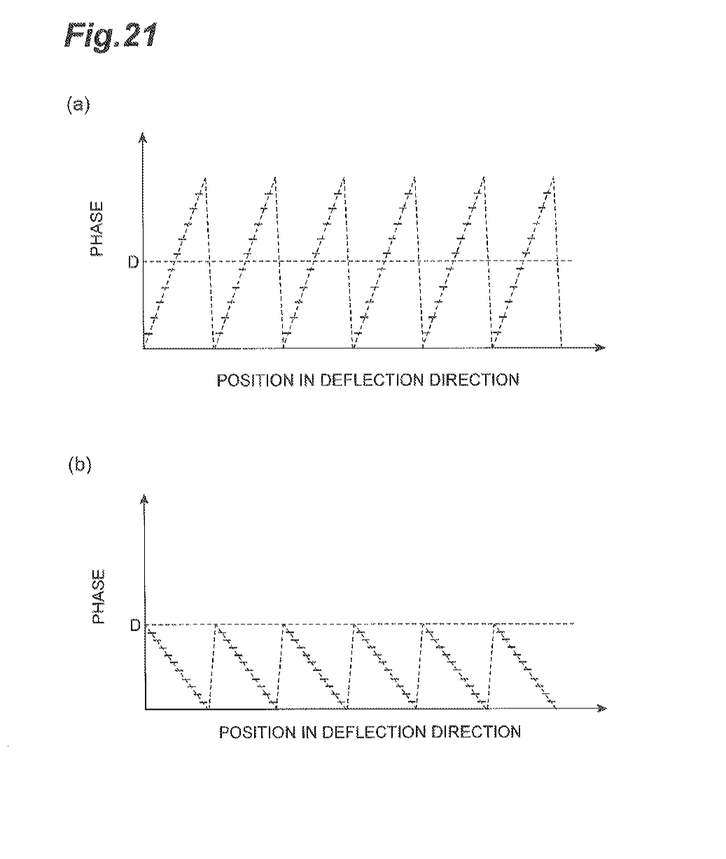

In the modification example, the first control voltage pattern is not limited to the control voltage pattern for presenting the phase modulation pattern illustrated in FIG. 19(b). For example, as illustrated in FIG. 21(b), the phase modulation pattern, which is configured by turning the pre-switching phase modulation pattern (illustrated in FIG. 21(a)) upside down while using the predetermined phase D as the axis of symmetry may have an increased or decreased phase value. In other words, the phase modulation pattern is configured by turning the pre-switching phase modulation pattern upside down while using the predetermined phase D as the axis of symmetry, and multiplying the phase value by k (here, k is a real number greater than zero). In the example illustrated in FIG. 19(b), k is equal to one.

### Second Modification Example

As described in the embodiment, when the amount of phase modulation presented to the phase modulation element 17 forms a diffraction grating shape in the deflective direction, as illustrated in FIG. 8(b), the light intensity of the 0^{th} order light A₀ decreases, and the light intensity of the adjacent 1^{st} order light A₁ increases. Accordingly, the period of a diffraction grating is set in such a way that 1^{st} order light with a wavelength component incident to the phase modulation element 17 is incident to a desired second port.

In this case, as illustrated in FIG. 8(b), in addition to the 1^{st} order light A₁, multiple lights including a 2^{nd} order light A₂, 3^{rd} or higher-order lights, a 1^{st} order light A⁻¹, −2^{nd} order light A₋₂, and −3^{rd} or negative higher-order lights arrive at the light input/output port 18. It is desirable that almost no lights other than the 1^{st} order light are incident to the second port, which is a coupling destination of the wavelength component, and other second ports. The reason for this is that when lights other than the 1^{st} order light are incident to the second port, the lights become the cause of noise light.

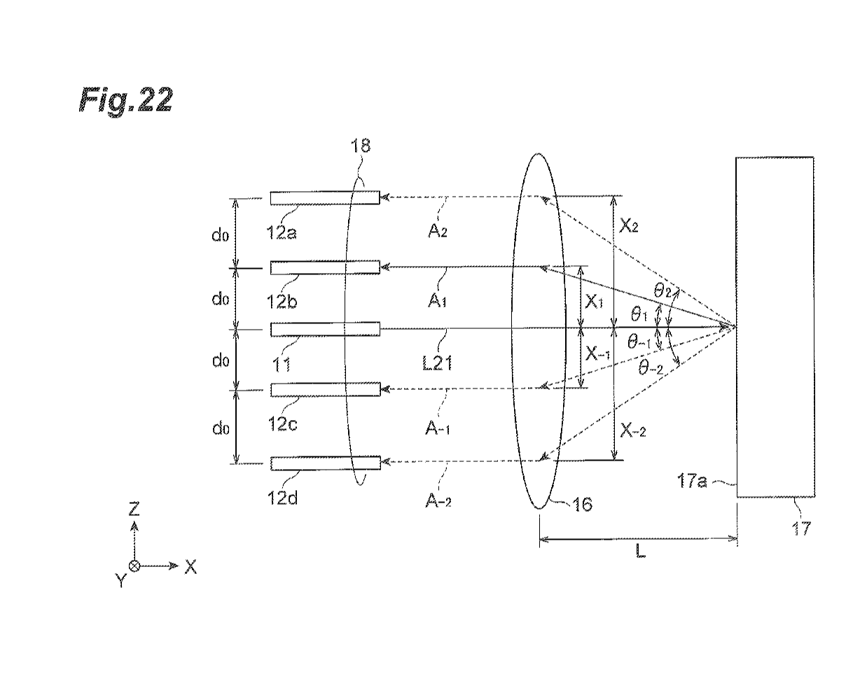

FIG. 22 is a schematic view illustrating the array of the light input/output port 18 in the embodiment. As illustrated in FIG. 22, in the embodiment, the first port 11 and the second ports 12a to 12d are arrayed equally spaced (gap d₀). In this configuration, the wavelength component L21 is deemed to be incident to the second port 12b. In this case, the 1^{st} order light A₁ of diffracted lights of the wavelength component L21 emitted from the phase modulation element 17 is incident to the second port 12b. In this case, −1^{st} order light A₋₁, the 2^{nd} order light A₂, and −2^{nd} order light A₋₂ are generated.

When it is assumed that the distance between the center of the converging lens 16 and the modulation surface 17a is L, and the inclination angle (light-emitting angle) of n^{th} order light A₀ (n is an integer) relative to the optical axis of the converging lens 16 is θₙ, with reference to the center axis of the converging lens 16, a position coordinate xₙ of a point at which the n^{th} order light Aₙ passes through the converging lens 16 is represented by the following expression.

Xₙ=L·sin(θₙ) (1)

The inclination angle θₙ of the n^{th} order light Aₙ is n times an inclination angle θ₁ of the 1^{st} order light A₁ (that is, θₙ=n·θ₁). The inclination angle θₙ is a very small angle, and thus the aforementioned expression (1) approximates to the following expression.

Xₙ=L·sin(θₙ)=L·sin(n·θ₁)≅nL·sin(θ₁) (2)

That is, the position coordinate Xₙ is n times a position coordinate x₁ of a point at which the 1^{st} order light A₁ passes through the converging lens 16. In other words, the points at which each order light pass through the converging lens 16 are equally spaced therebetween. Since this gap is maintained up to the light input/output port 18, as illustrated in FIG. 22, the arrival points of each order light arriving at the light input/output port 18 are equally spaced. For this reason, when the first port 11 and the second ports 12a to 12d are arrayed equally spaced (the gap d₀), the 1^{st} order light A₁ is incident to the second port 12b, the −1^{st} order light A₋₁ is incident to the second port 12c, the 2^{nd} order light A₂ is incident to the second port 12a, and the −2^{nd} order light A₋₂ is incident to the second port 12d.

In particular, since the −1^{st} order light A₋₁ is generated at a light-emitting angle symmetrical to the light-emitting angle of the 1^{st} order light A₁, when the second ports are symmetrically disposed on both sides of the first port 11 as in the embodiment, the −1^{st} order light A₋₁ is incident to the second port positioned symmetrically with respect to the second port to which the 1^{st} order light A₁ is incident. When the inclination angle θ₁ of the 1^{st} order light A₁ is large, the optical axis of the 2^{nd} order light A₂ or the −2^{nd} order light A₋₂ deviates from the light input/output port 18. In this case, a phase difference between the pixels of the phase modulation pattern increases, and thus the accuracy of the diffraction grating-shaped pattern is decreased, and the light intensity of the −1^{st} order light A₋₁ increases, which is a problem.

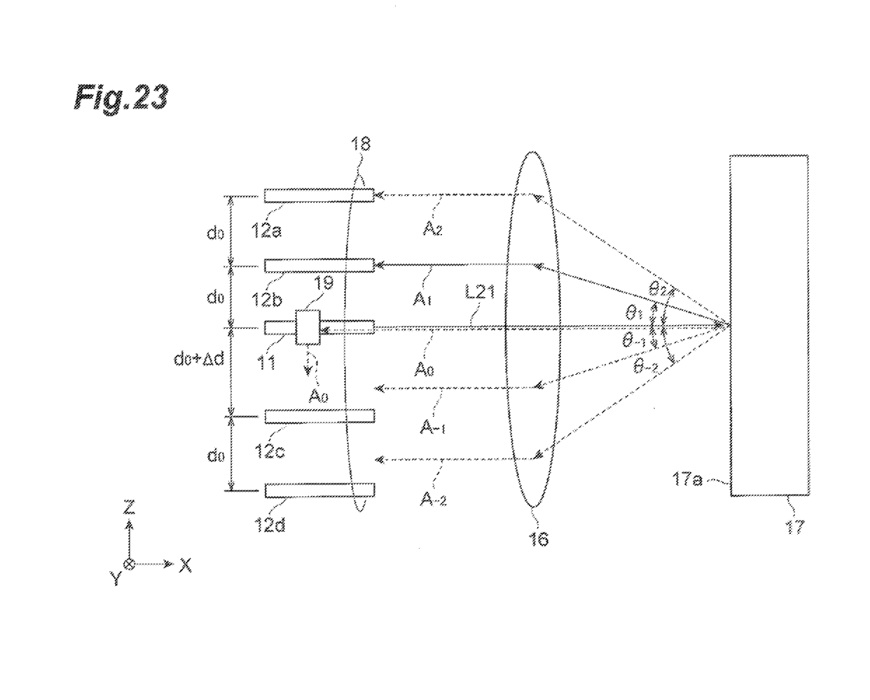

In the modification example, the relative dispositions of the first port 11 and the second ports 12a to 12d are set as illustrated in FIG. 23. The relative dispositions of the first port 11 and the second port 12b are set in such a way that the second port 12b is disposed on the optical axis of the 1^{st} order light A₁. Accordingly, the 1^{st} order light A₁ is incident to the second port 12b. In contrast, the relative dispositions of the first port 11 and the multiple second ports 12a, 12c, and 12d are set in such a way that the optical axis of the −1^{st} order light A₋₁, is positioned away from the second ports 12a, 12c, and 12d other than the second port 12b. As a result, it is possible to avoid the incidence of the −1^{st} order light A₋₁ to the other second ports 12a, 12c, and 12d, and to reduce the amount of light incident thereto.

The positioning of the −1^{st} order light A₋₁, away from the second ports 12a, 12c, and 12d means that the −1^{st} order light A₋₁, is apart from the second ports 12a, 12c, and 12d in such a way that the light intensity of the −1^{st} order light A₁ incident to the second ports 12a, 12c, and 12d is less than −30 dB with respect to the light intensity (maximum coupling intensity) of the 1^{st} order light A₁ incident to the second port 12b. The reason for this is that when the light intensity of the −1^{st} light A⁻¹ is less than −30 dB with respect to the light intensity of the 1^{st} order light A₁, its impact on optical communication can be sufficiently suppressed.

In the aforementioned description, the wavelength component L21 is exemplified, and the aforementioned description also applies to the wavelength components L22 and L23. That is, with regard to the wavelength component L22, the relative dispositions of the first port 11 and the multiple second ports 12a, 12b, and 12d are set in such a way that the optical axis of the −1^{st} order light A₋₁ with the wavelength component L22 is positioned away from the second ports 12a, 12b, and 12d other than the desired second port 12c. With regard to the wavelength component L23, the relative dispositions of the first port 11 and the multiple second ports 12a to 12c are set in such a way that the optical axis of the −1^{st} order light A₋₁ with the wavelength component L23 is positioned away from the second ports 12a to 12c other than the desired second port 12d.

In the example, one portion (the second ports 12a and 12b) of the input/output port 18 and the remaining portion (the second ports 12c and 12d) of the light input/output port 18 may be disposed non-symmetrically with respect to the optical axis of the 0^{th} order light A₀, with the optical axis of the 0^{th} order light A₀ being interposed therebetween. As a result, it is possible to suitably prevent the incidence of the −1^{st} order light A₋₁ to the second ports other than a desired second port. As illustrated in FIG. 23, when the remaining portion (the second ports 12c and 12d) of the light input/output port 18 are uniformly positioned by a distance Δd away from positions symmetrical to the positions of the one portion (the second ports 12a and 12b) relative to the optical axis of the 0^{th} order light A₀, the embodiment can be realized.

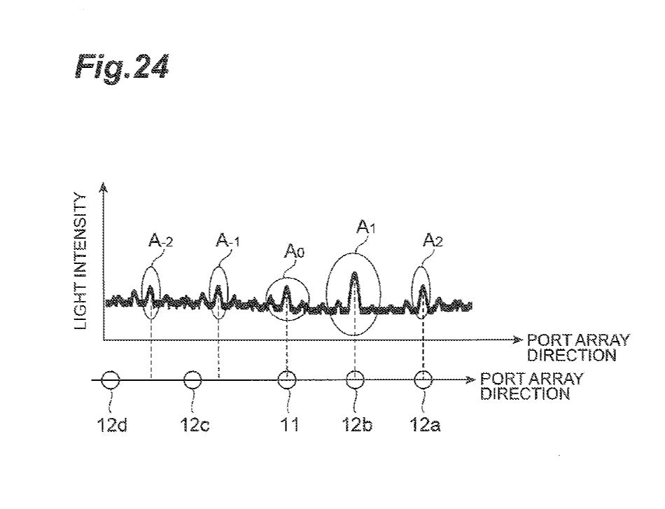

FIG. 24 is a graph illustrating a relationship between the light input/output port 18 illustrated in FIG. 23 and the distribution of light intensities of diffracted lights arriving at the light input/output port 18. As illustrated in FIG. 24, the position of the optical axis of the 1^{st} order light A₁ with the highest peak of light intensity in the port array direction is coincident with the position of the second port 12b (which is a coupling destination) in the port array direction. In contrast, the positions of the optical axes of the −1^{st} order light A₋₁ and the −2^{nd} order light A₂ in the port array direction deviate from the positions of the other second ports 12c and 12d in the port array direction. As a result, the 1^{st} order light A₁ can be suitably incident to the desired second port 12b, and it is possible to avoid (or to reduce the amount of incident light) the incidence of the −1^{st} order light A₋₁ and the −2^{nd} order light A₋₂ to the other second ports 12c and 12d.

As illustrated in FIG. 23, when light from the first port 11 is incident perpendicularly to the modulation surface 17a, the 0^{th} order light A₀ is reflected toward the first port 11. In this case, an isolator 19 may be provided in the first port 11. As a result, it is possible to effectively prevent the incidence of the 0^{th} order light A₀ to the first port 11. Alternatively, a phase modulation pattern for cancelling the 0^{th} order light A₀ may overlap the diffraction grating-shaped phase modulation pattern presented to the modulation surface 17a. As a result, it is possible to reduce the amount of the 0^{th} order light A₀, and to effectively prevent (or to reduce the amount of incident light) the incidence of the 0^{th} order light A₀ to the first port 11. Alternatively, the first port 11 may be disposed separately from the optical axis of the converging lens 16. As a result, it is possible to suitably avoid the incidence of the 0^{th} order light A₀ to the first port 11.

In particular, since the diffraction grating-shaped pattern disappears from the modulation surface 17a at the moment the control unit 20 supplies the first control voltage pattern to the phase modulation element 17, only the 0^{th} order light A₀ is generated (refer to FIG. 7(b)). As a result, the incidence of the 0^{th} order light A₀ to the first port 11 is desirably prevented.

In FIG. 24, for illustrative purposes, the second port 12a is present at a position at which the 2^{nd} order light A₂ is generated. When the inclination angle θ₁ of the 1^{st} order light A₁ is small, a phase difference between the pixels of the phase modulation pattern decreases, and thus the setting can be done in such a way that the accuracy of the diffraction grating-shaped pattern is increased, and the intensity of the 2^{nd} order light A₂ can be reduced to a negligible level. In contrast, when the inclination angle θ₁ of the 1^{st} order light A₁ is large, the optical axis of the 2^{nd} order light A₂ deviates from the light input/output port 18. As a result, when the inclination angle θ₁ of the 1^{st} order light A₁ is large, and the light intensity of the −1^{st} a order light A₋₁ becomes a problem by causing noise, the 2^{nd} order light A₂ is unlikely to become noise. That is, it is possible to suitably prevent the incidence of higher-order lights, which are diffracted by the phase modulation element 17, to the second ports by avoiding the incidence of the −1^{st} order light A₁ to the light input/output port 18.

### Third Modification Example

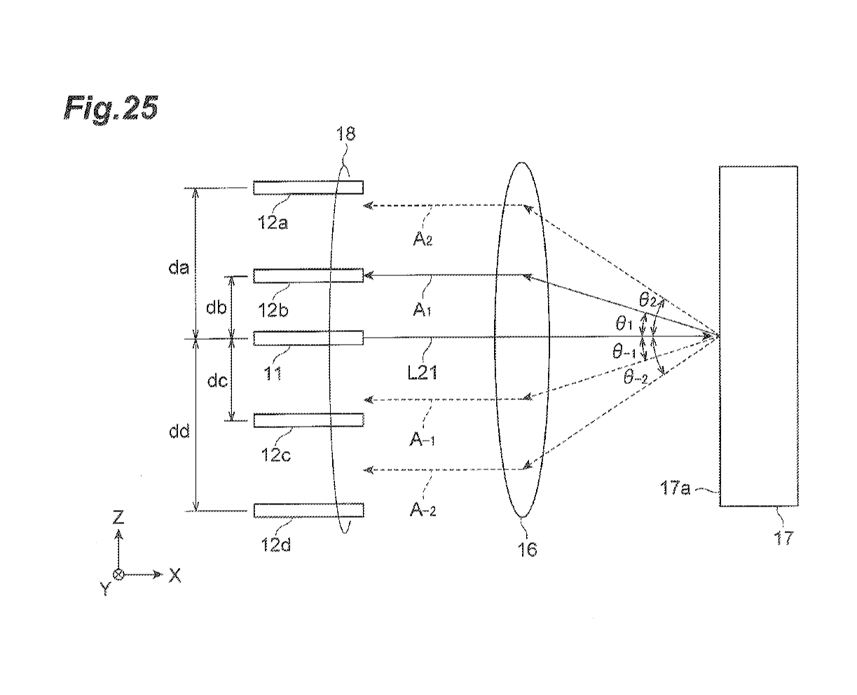

FIG. 25 is a view illustrating the relative disposition of the first port 11 and the multiple second ports 12a to 12d in a third modification example. In this example, the second port 12a is positioned away from the optical axis of the 2^{nd} order light A₂, and the 2^{nd} order light A₂ is not incident to the second port 12a. In this manner, the second port is preferably positioned away from the optical axis of positive higher-order light.

For example, when the ratios between distances da to dd from the optical axis of the 0^{th} order light A₀ to the second ports 12a to 12d are mutually prime (that is, have no integer divisors other than one and itself), the embodiment can be realized. With this port disposition, with regard to any one of the wavelength components L21 to L23, it is possible to suitably avoid (or to reduce the amount of incident light) the incidence of lights (the −1^{st} order light A₋₁, the 2^{nd} order light A₂, the −2^{nd} order light A₋₂, and higher-order lights) other than the 1^{st} order light A₁ to the second ports 12a to 12d.

### Fourth Modification Example

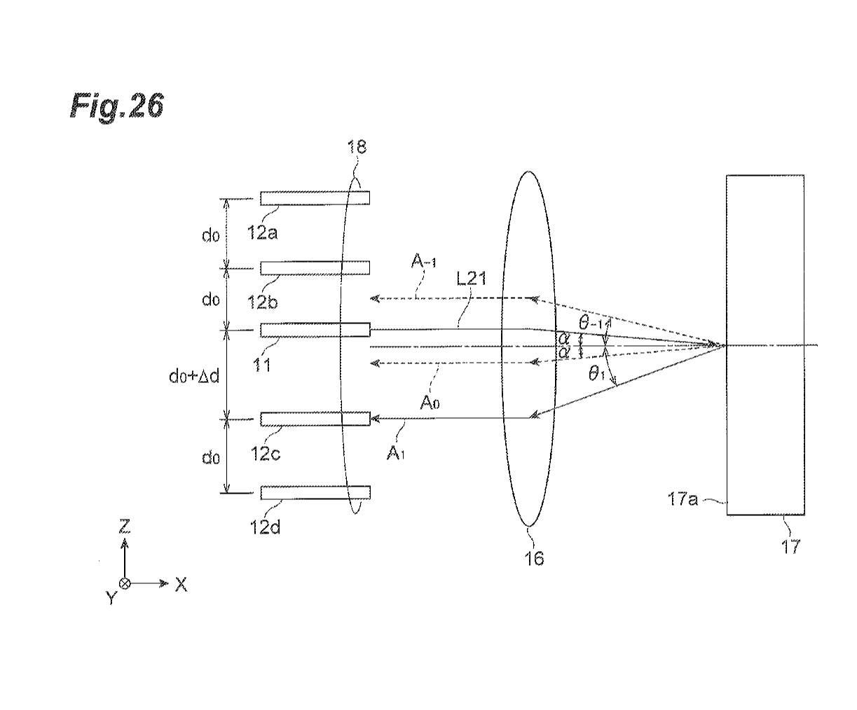

FIG. 26 is a view illustrating the relative disposition of the first port 11 and the multiple second ports 12a to 12d in a fourth modification example. In this example, the first port 11 is disposed offset from the optical axis of the lens 16, and thus the center axis line of the first port 11 is positioned away from the optical axis of the 0^{th} order light A₀. In other words, the optical axis of each of the wavelength components (the wavelength component L21 is illustrated in FIG. 26) incident to the phase modulation surface 17a is inclined by an angle α relative to a normal line of the phase modulation surface 17a. With the port disposition in this modification example, it is possible to effectively prevent the incidence of the 0^{th} order light A₀ to the first port 11. In particular, in the embodiment, the diffraction grating-shaped pattern disappears from the modulation surface 17a at the moment the control unit 20 supplies the first control voltage pattern to the phase modulation element 17, and thus the 0^{th} order light A₀ is generated (refer to FIG. 7(b)). As a result, the incidence of the 0^{th} order light A₀ to the first port 11 is desirably prevented as in the modification example.

The wavelength selective switch and the control method for the phase modulation element of the present invention are not limited to the embodiment, and various forms of modification can be made to the embodiment. In the description given with reference to the embodiment, the number of dispersed wavelength components is three; however, two or more dispersed wavelength components can be suitably applied to the present invention. The number of second ports of the light input/output port can be arbitrarily selected from numbers greater than or equal to the number of wavelength components.

In the embodiment, the LCOS-based phase modulation element is exemplified as a phase modulation element; however, the phase modulation element applicable to the present invention is not limited to this type, and it is possible to adopt various types of phase modulation element capable of presenting a diffraction grating-shaped phase modulation pattern.

### INDUSTRIAL APPLICABILITY

The present invention can be applied to the wavelength selective switch and the control method for the phase modulation element which are capable of suppressing the scattering of light when a coupling destination of a wavelength component is switched from one light input/output port to another light input/output port.

### REFERENCE SIGNS LIST

1A: WAVELENGTH SELECTIVE SWITCH
10: LIGHT INPUT/OUTPUT UNIT
11: FIRST PORT
12a to 12d: SECOND PORT
13: COLLIMATOR LENS
14: ANAMORPHIC OPTICAL SYSTEM
15: WAVELENGTH DISPERSIVE ELEMENT
16: CONVERGING LENS
17: PHASE MODULATION ELEMENT
17a: MODULATION SURFACE
17b to 17e: PHASE MODULATION REGION
18, 18A: LIGHT INPUT/OUTPUT PORT
19: ISOLATOR
20: CONTROL UNIT
A₋₁: −1^{th} ORDER LIGHT
A₋₂: −2^{nd} ORDER LIGHT
A₀: 0^{th} ORDER LIGHT
A₁: 1^{st} ORDER LIGHT
A₂: 2^{nd} ORDER LIGHT
Aₙ: n^{th} ORDER LIGHT
D: PREDETERMINED PHASE
d₀: GAP
L21 TO L23: WAVELENGTH COMPONENT

1. A wavelength selective switch comprising:
a light input/output unit in which light input/output ports are lined up in a predetermined direction, the light input/output ports including a first port through which light is input, and multiple second ports through which light is output;
a wavelength dispersive element optically coupled to the light input/output unit;
a phase modulation element having multiple pixels configured to perform phase modulation according to a control voltage applied to each of the pixels, and deflecting through diffraction the optical path of a wavelength component arriving at the phase modulation element from the first port through the wavelength dispersive element, toward any one of the multiple second ports by presenting a diffraction grating-shaped phase modulation pattern; and
a control unit configured to supply a control voltage pattern to the phase modulation element so as to present the phase modulation pattern,
wherein, when the optical path of the wavelength component is switched from one to another of the multiple second ports, the control unit supplies a first control voltage pattern such that the phase modulation amount of the phase modulation pattern for deflecting the optical path of the wavelength component toward a pre-switching second port is reduced while the period of a diffraction grating is maintained to the phase modulation element, and thereafter, supplies a second control voltage pattern for deflecting the optical path of the wavelength component toward the other second port to the phase modulation element.

2. The wavelength selective switch according to claim 1,
wherein the first control voltage pattern is a control voltage pattern for presenting a phase modulation pattern having a substantially uniform distribution of the phase modulation amount.

3. The wavelength selective switch according to claim 1,
wherein the first control voltage pattern is a control voltage pattern for presenting a phase modulation pattern configured by reversing the phase modulation pattern for deflecting the optical path of the wavelength component toward the pre-switching second port while using a predetermined phase as the axis of symmetry, and multiplying the phase value by k (here, k is a real number greater than zero).

4. The wavelength selective switch according to claim 1,
wherein the first port and the multiple second ports are disposed in such a way that 1^{st} order light of the wavelength component deflected by the phase modulation element is incident to a desired second port, and the optical axis of −1^{st} order light of the wavelength component is positioned away from the second ports other than the desired second port.

5. The wavelength selective switch according to claim 4,
wherein one portion of the light input/output ports and the remaining portion of the light input/output ports are disposed such that the optical path of 0^{th} order light of the wavelength component deflected by the phase modulation element is interposed therebetween, and the one portion and the remaining portion are disposed non-symmetrically with respect to the optical axis of the 0^{th} order light.

6. The wavelength selective switch according to claim 4,
wherein ratios between the distances from the optical axis of the 0^{th} order light of the wavelength component deflected by the phase modulation element to the light input/output ports are mutually prime.

7. The wavelength selective switch according to claim 1,
wherein a center axis line of the first port is positioned away from the optical axis of the 0^{th} order light of the wavelength component deflected by the phase modulation element.

8. The wavelength selective switch according to claim 1,
wherein an isolator is provided in the first port, or a phase modulation pattern for canceling the 0^{th} order light of the wavelength component deflected by the phase modulation element overlaps the diffraction grating-shaped phase modulation pattern.

9. A control method for a phase modulation element which has multiple pixels configured to perform phase modulation according to a control voltage applied to each of the pixels, and deflects the optical path of light in a desired direction by presenting a diffraction grating-shaped phase modulation pattern, the method comprising:
Supplying, when the optical path of the light is switched from one direction to another direction, a first control voltage pattern such that the phase modulation amount of the phase modulation pattern for deflecting the optical path of the light toward the one direction is reduced while the period of a diffraction grating is maintained to the phase modulation element, and thereafter, supplying a second control voltage pattern for deflecting the optical path of the light toward the other direction to the phase modulation element.
